(19) United States
(12) Patent Application Publication
(10) Pub. No.: US 2010/0253167 A1
(43) Pub. Date: Oct. 7, 2010

(54) ELECTRIC MOTOR/GENERATOR ASSEMBLY

(75) Inventors: John Clifford Charnley, Newcastle-upon-Tyne (GB); Clinton Eugene Sheppard, Mountain Home, AZ (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: SHEPPARD & CHARNLEY LIMITED, Gateshead (GB)

(21) Appl. No.: 12/669,428

(22) PCT Filed: Jul. 16, 2008
(86) PCT No.: PCT/GB08/50579

§ 371 Date: Jun. 3, 2010

(30) Foreign Application Priority Data
Jul. 17, 2007 (GB) 0713864.7

(51) Int. Cl. H02K 7/06; F04D 3/00; H02K 3/26

(52) U.S. Cl. 310/83; 417/354; 310/208

(57) ABSTRACT

An apparatus comprises a rotor supported for rotation about a longitudinal axis. The rotor comprises an elongate tubular member enclosing a substantially cylindrical space, the elongate tubular member having a first open end defining an inlet, and a second open end defining an outlet. The apparatus includes at least one electrically conductive element for generating a magnetic field when electric current flows therethrough and for controlling rotation of the rotor. At least a part of at least one said electrically conductive element is aligned axially with at least a part of said elongate tubular member. The elongate tubular member comprises conveying means adapted so that upon rotation of said rotor, at least one body is caused to move in a direction from said inlet toward said outlet, through the substantially cylindrical space.

The present invention relates to an apparatus for moving a body from one place to another, which can also be operated in reverse such that an electro motive force is generated upon movement of a body from one place to another. Although the present invention has applications in numerous areas of technology such as power tools, the present invention is particularly, but not exclusively suitable for use within the circulatory system of a patient. In this way, the present invention can be used to assist in the pumping of blood throughout the patient's circulatory system, or to utilise the flow of blood to generate an electrical current to provide power to an electrical device such as a pace maker implanted in another part of the patient's body.

An aim of the present invention is to provide an apparatus which overcomes or at least alleviates the problems associated with known apparatuses for moving a body from one place to another.

A further aim of the present invention is to provide an apparatus which overcomes or at least alleviates the problems associated with known apparatuses for generating an electro motive force upon movement of a body from one place to another.

In accordance with a first aspect of the present invention there is provided an apparatus comprising:—
(i) a rotor supported for rotation about a longitudinal axis, said rotor comprising an elongate tubular member enclosing a substantially cylindrical space, said elongate tubular member having a first open end defining an inlet, and a second open end defining an outlet; and
(ii) at least one electrically conductive element for generating a magnetic field when electric current flows therethrough and for controlling rotation of the rotor, wherein at least a part of at least one said electrically conductive element is aligned axially with at least a part of said elongate tubular member,
   wherein said elongate tubular member comprises conveying means adapted so that upon rotation of said rotor, at least one body is caused to move in a direction from said inlet toward said outlet, through the substantially cylindrical space.

At least one said body may be either a fluid or a solid material.

In arranging the electrically conductive element so that at least a part thereof is aligned axially with at least a part of the elongate tubular member, the apparatus can be made to be small enough to be fitted inside the bloodstream of a patient. In particular, the length of the apparatus may be kept to a minimum, thereby facilitating its insertion into blood vessels that are not completely straight.

Moreover, in arranging the electrically conductive element so that at least a part thereof is aligned axially with at least a part of the elongate tubular member, the apparatus is particularly applicable to use within a patient's bloodstream in that it may be selectively inserted into those parts of the patient's bloodstream which require circulatory assistance, without the requirement for major surgery. To elaborate, the apparatus may be arranged such that the elongate tubular member is disposed within the patient's bloodstream whilst the electrically conductive element may be arranged around and at least partially overlapping with the elongate tubular member but outside of the patient's bloodstream, for example around the external wall of the blood vessel. Whilst the presence of the blood vessel wall between the electrically conductive element and the elongate tubular member could potentially reduce the torque applied to the rotor for a given current applied to the electrically conductive element, it is to be appreciated that a useful torque could still be achieved using this arrangement. In this way, although the efficiency of the apparatus may be reduced using this arrangement, useful assistance may still be provided to the heart.

In arranging the elongate tubular member so that it is disposed within the patient's bloodstream whilst the electrically conductive element is arranged around and at least partially overlapping with the elongate tubular member but outside of the patient's bloodstream, this provides the advantage that the assistance provided to the heart in terms of the torque applied to the rotor may be conveniently controlled externally to the patient's body, for example by means of regulating the current flowing through the electrically conductive element from outside of the patient's body as necessary. This provides the further advantage that the drag which would otherwise be caused by the presence of the electrically conductive element in the patient's bloodstream, is reduced. Moreover, this provides the further advantage that the apparatus is less invasive to the patient.

In providing for the passage of fluid for example through the elongate tubular member in a direction from the inlet towards the outlet, the apparatus may be disposed at any suitable location in the patient's bloodstream.

In providing a rotor comprising an elongate tubular member enclosing a substantially cylindrical space, whereby a fluid for example can flow along a path defined by the substantially cylindrical space, this provides the advantage that drag, which may otherwise reduce the beneficial effects of the apparatus in terms of its assistance to the heart, is reduced. To elaborate, by virtue of the provision of a path defined by the substantially cylindrical space, the path has an increased cross-sectional area and in the case where at least one said body is fluid, the fluid flow is less restricted than in prior art apparatuses. In this way, the apparatus is substantially hollow, that is, open, without the central shaft typically seen in prior art devices which involve the rotation of a rotor. As a consequence, resistance to fluid flow through the apparatus is reduced, thereby increasing the fluid flow rate.

The conveying means may be adapted so that upon rotation of said rotor, fluid is conveyed in a direction from said inlet towards said outlet through the substantially cylindrical space. It is to be appreciated that the term conveying is understood as meaning the movement from one place to another. This movement could be for example, partially along the length of the elongate tubular member, or alternatively, along the complete length of the elongate tubular member from the inlet to the outlet.

Alternatively, the conveying means may be adapted so that upon rotation of said rotor, a solid body is caused to move in a direction from said inlet towards said outlet through the substantially cylindrical space.

It is to be appreciated that the apparatus enables either a solid or a fluid to be conveyed from one place to another; that is, caused to move at least part of the way along the longitudinal axis of the elongate tubular member. In this way, the apparatus can function as a pump for example, whereby fluid is urged through the elongate tubular member when electric current flows through the electrically conductive element. Alternatively, the apparatus can function as an actuator apparatus for example, whereby a solid body such as a threaded metallic member is conveyed through the elongate tubular member when electric current flows through the electrically conductive element.

Preferably, at least one said electrically conductive element is disposed radially outwardly of said elongate tubular member.

Alternatively, said elongate tubular member may be disposed radially outwardly of at least one said electrically conductive element.

Preferably, the rotor comprises a plurality of magnets disposed around the periphery of said elongate member.

In the case where said electrically conductive element is disposed radially outwardly of the elongate tubular member, it is preferable that the rotor comprises a plurality of magnets disposed around the periphery of an outer surface of said elongate tubular member, and at least a part of at least one said electrically conducting element is disposed such that when electric current flows therethrough, said magnets are disposed in the magnetic field generated as a result of said electric current.

Alternatively, in the case where said elongate tubular member is disposed radially outwardly of the electrically conductive element, it is preferable that the rotor comprises a plurality of magnets disposed around the periphery of an inner surface of said elongate tubular member, and at least a part of at least one said electrically conducting element is disposed such that when electric current flows therethrough, said magnets are disposed in the magnetic field generated as a result of said electric current.

At least one said magnet may be a rare earth magnet.

This provides the advantage that cogging effects of the apparatus are reduced.

At least one said magnet may be elongate, with said magnets being arranged around the periphery of said elongate tubular member so that each said elongate magnet extends substantially parallel to said longitudinal axis of said rotor.

This provides the advantage that the torque applied to the rotor is maximised for a given amount of current flowing through the electrically conductive element.

The elongate tubular member may comprise a magnetically conductive material.

This provides the advantage that the magnetic field will be increased substantially with the result that the torque applied to the rotor is maximised for a given amount of current flowing through the electrically conductive element.

Preferably, the apparatus further comprises a tubular stator.

This provides the advantage that the apparatus is robust.

Preferably, said tubular stator comprises a magnetically conductive material.

Preferably, at least a part of said stator is axially aligned with at least a part of said elongate tubular member.

The stator may be disposed radially outwardly of said electrically conductive element. Alternatively, the stator may be disposed radially inwardly of said electrically conductive element.

Said electrically conductive element may comprise at least one coil, wherein a longitudinal axis extending through the centre of at least one said coil is substantially aligned with the longitudinal axis of said rotor.

The apparatus may further comprise a support assembly for supporting said rotor for rotation about said longitudinal axis of said rotor.

Preferably, said support assembly is disposed radially outwardly of said elongate tubular member.

This provides the advantage that a central shaft to facilitate rotational movement of the rotor is not required, thereby further reducing resistance to fluid flow.

Said support assembly may be disposed between said elongate tubular member and said tubular stator.

Said support assembly may be a physical support assembly.

This provides the advantage that a non-physical support assembly, for example a magnetic or hydrodynamic support assembly, is not required, thereby reducing the cost of manufacture of the apparatus.

The support assembly may comprise a plurality of ball bearings disposed around the periphery of an outer surface of said elongate tubular member.

In the case where the tubular stator is disposed outwardly of said elongate tubular member, this provides the advantage that the rotor is maintained substantially centrally within the magnetic tubular stator. Moreover, this provides the advantage that friction is reduced.

The conveying means may be disposed on an inner surface of the elongate tubular member.

Said conveying means may comprise at least one radially extending impeller disposed on an inner surface of the elongate tubular member, each said impeller having a first end attached to the inner surface of said elongate tubular member, and a free second end.

Preferably, each said impeller extends in the axial direction of said rotor between said inlet and said outlet, and more preferably each said impeller extends substantially parallel to said longitudinal axis of said rotor between said inlet and said outlet.

Alternatively, said conveying means comprises a plurality of discrete first radially extending impellers disposed around an inner surface of the elongate tubular member adjacent the inlet, and a plurality of discrete second radially extending impellers disposed around the inner surface of the elongate tubular member adjacent the outlet.

This configuration of impellers provides the advantage that it can be used in the case where the rotor is disposed radially outwardly of the electrically conductive element.

This provides the further advantage that the impellers are able to pump fluid for example, in a direction from the inlet towards the outlet, but do not themselves unduly restrict the flow of fluid therebetween.

Alternatively, said conveying means comprises screw threads disposed on an inner surface of said elongate tubular member. This provides the advantage that a solid body in the form of a threaded member having respective screw threads, can be caused to move from the inlet towards the outlet as the rotor rotates.

Preferably, at least one said electrically conductive element comprises at least one electrical conductor disposed on a tubular flexible substrate.

Preferably, said tubular flexible substrate is supported by an outer surface of said magnetically conductive tubular stator.

Alternatively, said tubular flexible substrate is supported by an inner surface of said magnetically conductive tubular stator.

This provides the advantage that the apparatus is easy to assemble.

This provides the further advantage that the apparatus is lightweight and compact and is therefore particularly suitable for insertion into the bloodstream of a patient.

Said tubular flexible substrate may comprise Kapton®.

Said electrically conductive element may comprise:—at least one first electrically conductive coil disposed on an inner surface of said tubular flexible substrate such that each said first electrically conductive coil lies substantially flat against the inner surface of said tubular flexible substrate; and at least one second electrically conductive coil disposed on an outer surface of said tubular flexible substrate such that each said second electrically conductive coil lies substantially flat against the outer surface of said tubular flexible substrate, wherein the longitudinal axes extending through the centre of said first and second coils are each substantially perpendicular to said longitudinal axis of said rotor.

Said electrically conductive element may comprise:—
(i) at least one first electrically conductive coil wherein the longitudinal axis extending through the centre of at least one said first coil is substantially perpendicular to said longitudinal axis of said rotor; and
(ii) at least one second electrically conductive coil wherein the longitudinal axis extending through the centre of at least one said second coil is substantially perpendicular to said longitudinal axis of said rotor;
   wherein at least one said first electrically conductive coil lies in substantially the same plane as at least one said second electrically conductive coil, and wherein at least a part of at least one said first electrically conductive coil overlaps with at least a part of at least one said second electrically conductive coil.

This provides the advantage that the torque applied to the rotor is maximised for a given amount of current flowing through the electrically conductive element.

Preferably, said electrically conductive element comprises a plurality of first electrically conductive coils connected in series with each other and a plurality of second electrically conductive coils connected in series with each other.

This provides the advantage that the torque applied to the rotor is maximised for a given amount of current flowing through the electrically conductive element.

Preferably, said electrically conductive coils are arranged such that at least a part of each said first electrically conductive coil overlaps with at least a part of a respective said second electrically conductive coil.

This provides the advantage that the direction of rotation of the rotor can be controlled externally. Moreover, this provides the advantage that the speed of rotation of the rotor can be controlled by way of applying electric current to the electrically conductive coils such that electric current is flowing through at least two said electrically conductive coils at any one time.

The apparatus may be incorporated into a vacuum cleaner.

This provides the advantage that the flow of air through the substantially cylindrical space as a result of the rotation of the elongate tubular member along with the conveying means, can generate suction. The resulting vacuum cleaner has the further advantage of being lightweight and compact on account of the hollow nature of the elongate tubular member.

Alternatively, the apparatus may be incorporated into an actuator device. In this case, the rotation of the elongate tubular member is able to convey a solid body through the substantially cylindrical space.

Alternatively, the apparatus may be incorporated into a dispensing apparatus for dispensing granular or grain like products, for example.

Alternatively, the apparatus may be incorporated into a device for lifting water.

Alternatively, the apparatus may be incorporated into a device for conveying oil along a pipeline.

Alternatively, the apparatus may be incorporated into an under water propulsion system.

In accordance with a second aspect of the present invention there is provided an electric motor assembly comprising:—
(i) a rotor supported for rotation about a longitudinal axis; and
(ii) at least one electrically conductive element for generating a magnetic field when electric current flows therethrough and for controlling rotation of the rotor,
   wherein at least one said electrically conductive element comprises at least one electrical conductor disposed on a tubular flexible substrate.

This provides the advantage that the electric motor assembly is easy to assemble.

This provides the further advantage that the electric motor assembly is compact and lightweight, and is therefore particularly suitable for insertion into the bloodstream of a patient, or incorporation into a power tool for example.

Preferably, said tubular flexible substrate is disposed radially outwardly of said rotor. Alternatively, said tubular flexible substrate may be disposed radially inwardly of said rotor.

Preferably, said rotor comprises an elongate tubular member enclosing a substantially cylindrical space, said elongate tubular member having a first open end defining an inlet, and a second open end defining an outlet.

In having an elongate tubular member enclosing a substantially cylindrical space, this provides the advantage that the electric motor assembly is hollow, that is open, without a shaft. This provides the advantage that the substantially cylindrical space may be used for storage of consumables. For example, in the event that the electric motor assembly is incorporated into an electric drill or a power screwdriver for example, drill bits or screwdriver bits could potentially be stored in the substantially cylindrical space.

Said elongate tubular member may comprise conveying means adapted so that upon rotation of said rotor, a body is caused to move in a direction from said inlet toward said outlet through the substantially cylindrical space.

The motor assembly may further comprise a tubular stator comprising a magnetically conductive material.

Preferably, at least a part of said stator overlaps with at least a part of said elongate tubular member.

Preferably, at least a part of said electrically conductive element overlaps with at least a part of said elongate tubular member.

Said tubular flexible substrate may be supported by an outer surface of said tubular stator. Alternatively, said tubular flexible substrate may be supported by an inner surface of said tubular stator.

Said tubular flexible substrate may comprise Kapton®.

Said electrically conductive element may comprise:—at least one first electrically conductive coil disposed on an inner surface of said tubular flexible substrate such that each said first electrically conductive coil lies substantially flat against the inner surface of said tubular flexible substrate; and at least one second electrically conductive coil disposed on an outer surface of said tubular flexible substrate such that each said second electrically conductive coil lies substantially flat against the outer surface of said tubular flexible substrate, wherein the longitudinal axes extending through the centre of said first and second coils are each substantially perpendicular to said longitudinal axis of said rotor.

Said electrically conductive element may comprise:—
(iii) at least one first electrically conductive coil wherein the longitudinal axis extending through the centre of at least one said first coil is substantially perpendicular to said longitudinal axis of said rotor; and
(iv) at least one second electrically conductive coil wherein the longitudinal axis extending through the centre of at least one said second coil is substantially perpendicular to said longitudinal axis of said rotor;
   wherein at least one said first electrically conductive coil lies in substantially the same plane as at least one said second electrically conductive coil, and wherein at least a part of at least one said first electrically conductive coil overlaps with at least a part of at least one said second electrically conductive coil.

Preferably, said electrically conductive element comprises a plurality of first electrically conductive coils connected in series with each other and a plurality of second electrically conductive coils connected in series with each other.

Preferably, said tubular stator comprises a plurality of first elements and said tubular flexible substrate comprises a plurality of corresponding second elements which register with respective said first elements to retain said tubular flexible substrate in place relative to said tubular stator.

This provides the advantage that the tubular flexible substrate and hence the first and second electrically conductive coils disposed thereon are maintained in a position which facilitates the generation of a magnetic field in the region of said magnets on said elongate tubular member.

The electric motor assembly may be incorporated into a power tool; for example, a power drill.

This provides the advantage that the power tool is lightweight and compact. A power tool incorporating an electric motor assembly comprising an elongate tubular member enclosing a substantially cylindrical space has the advantage that the substantially cylindrical space may be utilised to store consumables such as drill bits, on account of the hollow nature of the elongate tubular member.

In accordance with a third aspect of the present invention there is provided an electric motor assembly comprising:—
(i) a rotor supported for rotation about a longitudinal axis;
(ii) at least one electrically conductive element for generating a magnetic field when electric current flows therethrough and for controlling rotation of the rotor; and
(iii) a stator disposed radially inwardly of said rotor,
   wherein at least one said electrically conductive element is disposed radially outwardly of said stator.

In providing the electrically conductive element radially outwardly of the stator as opposed to radially inwardly thereof, this provides the advantage that the air gap between the electrically conductive element and the rotor may be reduced. This in turn provides the advantage that smaller and therefore lower cost magnets may be used on the rotor to generate a useful magnetic field. In this way, the manufacturing cost of the electric motor assembly is reduced, and the electric motor assembly may be small, thereby further facilitating its insertion into the bloodstream of a patient.

Moreover, in having a smaller air gap, the magnetic efficiency of the electric motor assembly is improved.

Preferably, said electrically conductive element is disposed between said stator and said rotor.

Preferably, said rotor comprises an elongate tubular member enclosing a substantially cylindrical space, said elongate tubular member having a first open end defining an inlet, and a second open end defining an outlet.

Preferably, said elongate tubular member comprises conveying means adapted so that upon rotation of said rotor, fluid is caused to move in a direction from said inlet toward said outlet through the substantially cylindrical space.

Alternatively, said elongate tubular member comprises conveying means adapted so that upon rotation of said rotor, a solid body is caused to move in a direction from said inlet toward said outlet through the substantially cylindrical space.

This provides the advantage that the electric motor assembly may be incorporated in an actuator for example, or in a dispensing means. For example, in the case where the electric motor assembly is incorporated in a dispensing means, if a certain amount of electrical current is supplied to the electrically conductive element for a certain length of time, then a certain amount of solid material, such as grain, could be dispensed.

In accordance with a fourth aspect of the present invention there is provided an electric motor assembly comprising:—
(iii) a rotor supported for rotation about a longitudinal axis; and
(iv) at least one electrically conductive element for generating a magnetic field when electric current flows therethrough and for controlling rotation of the rotor,
   wherein at least one said electrically conductive element comprises at least one first electrically conductive coil disposed on the inner surface of a tubular substrate such that each said first electrically conductive coil lies substantially flat against the inner surface of said tubular substrate; and at least one second electrically conductive coil disposed on an outer surface of said tubular substrate such that each said second electrically conductive coil lies substantially flat against the outer surface of said tubular substrate, wherein the longitudinal axes extending through the centre of said first and second coils are each substantially perpendicular to said longitudinal axis.

In accordance with a fifth aspect of the present invention there is provided an electric motor assembly comprising:—
(i) a rotor supported for rotation about a longitudinal axis; and
(ii) at least one electrically conductive element for generating a magnetic field when electric current flows therethrough and for controlling rotation of the rotor,
   wherein at least one said electrically conductive element comprises:—at least one first electrically conductive coil wherein the longitudinal axis extending through the centre of at least one said first coil is substantially perpendicular to said longitudinal axis of said rotor; and at least one second electrically conductive coil wherein the longitudinal axis extending through the centre of at least one said second coil is substantially perpendicular to said longitudinal axis of said rotor; wherein at least one said first electrically conductive coil lies in substantially the same plane as at least one said second electrically conductive coil, and wherein at least a part of at least one said first electrically conductive coil overlaps with at least a part of at least one said second electrically conductive coil.

Preferably, said electrically conductive coils are arranged such that at least a part of each said first electrically conductive coil overlaps with at least a part of a respective said second electrically conductive coil.

Said rotor may comprise conveying means adapted so that upon rotation of said rotor, fluid is caused to move from said inlet toward said outlet through the substantially cylindrical space.

In accordance with a sixth aspect of the present invention there is provided an electric motor assembly comprising:—
(i) a rotor supported for rotation about a longitudinal axis, said rotor comprising an elongate tubular member; and
(iii) at least one electrically conductive element for generating a magnetic field when electric current flows therethrough and for controlling rotation of the rotor,
   wherein said motor assembly further comprises an assembly of gears disposed within said elongate tubular member.

Preferably, at least one said electrically conductive element is disposed radially outwardly of said rotor.

In accordance with a seventh aspect of the present invention there is provided an electric motor assembly comprising:—
(i) a rotor supported for rotation about a longitudinal axis; and
(ii) at least one electrically conductive element for generating a magnetic field when electric current flows therethrough and for controlling rotation of the rotor,
   wherein said rotor comprises a plurality of magnets disposed end to end and substantially parallel to said longitudinal axis.

Preferably, said electrically conductive element comprises a plurality of electrically conductive coils disposed end to end and substantially parallel to said longitudinal axis such that each magnet overlaps with a respective electrically conductive coil.

In accordance with an eighth aspect of the present invention there is provided an apparatus comprising:—
(iv) a rotor supported for rotation about a longitudinal axis, said rotor comprising an elongate tubular member enclosing a substantially cylindrical space, said elongate tubular member having a first open end defining an inlet, and a second open end defining an outlet; and
(v) at least one electrically conductive element, wherein at least a part of at least one said electrically conductive element is aligned axially with at least a part of said elongate tubular member,
   wherein said elongate tubular member comprises drive means adapted so that when at least one body moves in a direction from said inlet toward said outlet through the substantially cylindrical space, said rotor is caused to rotate about said longitudinal axis to thereby induce an electro motive force in at least one said electrically conductive element.

This provides the advantage that the apparatus may be disposed in the bloodstream of a patient, with the electro motive force generated being used to supply power to an electronically operated device implanted at a different part of the patient's body when the electrically conductive element is connected to said electrically operated device. This in turn provides the advantage that service costs associated with battery powered implanted devices in particular, are significantly reduced.

In providing a rotor in the form of an elongate tubular member enclosing a substantially cylindrical space, whereby at least one said body is able to move through the substantially cylindrical space, this provides the advantage that the path has an increased cross-sectional area. Moreover, in the case where the body is a fluid, the fluid flow is less restricted than in prior art apparatuses. This has particular advantages in the event that the apparatus is disposed in the bloodstream of a patient since the presence of drag in the bloodstream of the patient could otherwise reduce their blood pressure, leading to potentially catastrophic results. In this way, the pressure drop across the apparatus is small and whilst this can in some circumstances reduce the efficiency of the apparatus, an electro motive force which is able to carry out a worthwhile job can still be generated. This is evidenced by the statistic that a typical heart pacemaker only consumes between 10 and 40 microwatts.

It is to be appreciated that the conveying means recited earlier may be configured in the same or a similar fashion to the drive means recited according to the sixth aspect of the present invention. In this way, the apparatus according to the first aspect of the invention may be operated in reverse in accordance with a sixth aspect of the invention.

The drive means may comprise at least one radially extending impeller disposed on an inner surface of the elongate tubular member

In accordance with a ninth aspect of the present invention there is provided an electric generator assembly comprising:—
(i) a rotor supported for rotation about a longitudinal axis; and
(ii) at least one electrically conductive element in which an electro motive force is generated when said rotor rotates,
   wherein at least one said electrically conductive element comprises at least one electrical conductor disposed on a tubular flexible substrate.

In accordance with a tenth aspect of the present invention there is provided an electric generator assembly comprising:—
(i) a rotor supported for rotation about a longitudinal axis;
(ii) at least one electrically conductive element in which an electro motive force is generated when said rotor rotates; and
(iii) a stator disposed radially inwardly of said rotor,
   wherein at least one said electrically conductive element is disposed radially outwardly of said stator.

In accordance with an eleventh aspect of the present invention there is provided an electric generator assembly comprising:—
(v) a rotor supported for rotation about a longitudinal axis; and
(vi) at least one electrically conductive element in which an electro motive force is generated when said rotor rotates,
   wherein at least one said electrically conductive element comprises at least one first electrically conductive coil disposed on the inner surface of a tubular substrate such that each said first electrically conductive coil lies substantially flat against the inner surface of said tubular substrate; and at least one second electrically conductive coil disposed on an outer surface of said tubular substrate such that each said second electrically conductive coil lies substantially flat against the outer surface of said tubular substrate, wherein the longitudinal axes extending through the centre of said first and second coils are each substantially perpendicular to said longitudinal axis.

In accordance with a twelfth aspect of the present invention there is provided an electric generator assembly comprising:—
(i) a rotor supported for rotation about a longitudinal axis; and
(ii) at least one electrically conductive element in which an electro motive force is generated when said rotor rotates,
   wherein at least one said electrically conductive element comprises:—
(v) at least one first electrically conductive coil wherein the longitudinal axis extending through the centre of at least one said first coil is substantially perpendicular to said longitudinal axis of said rotor; and
(vi) at least one second electrically conductive coil wherein the longitudinal axis extending through the centre of at least one said second coil is substantially perpendicular to said longitudinal axis of said rotor;
   wherein at least one said first electrically conductive coil lies in substantially the same plane as at least one said second electrically conductive coil, and wherein at least a part of at least one said first electrically conductive coil overlaps with at least a part of at least one said second electrically conductive coil.

In accordance with a thirteenth aspect of the present invention there is provided an electric generator assembly comprising:—
(i) a rotor supported for rotation about a longitudinal axis, said rotor comprising an elongate tubular member; and
(vi) at least one electrically conductive element in which an electro motive force is generated when said rotor rotates,
   wherein said electric generator assembly further comprises an assembly of gears disposed within said elongate tubular member.

In accordance with a fourteenth aspect of the present invention there is provided an electric generator assembly comprising:—
(i) a rotor supported for rotation about a longitudinal axis; and
(ii) at least one electrically conductive element in which an electro-motive force is generated when said rotor rotates,
   wherein said rotor comprises a plurality of magnets disposed end to end substantially parallel to said longitudinal axis.

Preferably, said electrically conductive element comprises a plurality for electrically conductive coils dispersed end to end and parallel to said longitudinal axis such that each magnet overlaps with a respective electrically conductive coil

Preferred embodiments of the present invention will now be described, by way of example only and not in any limitative sense, with reference to the accompanying drawings in which:—

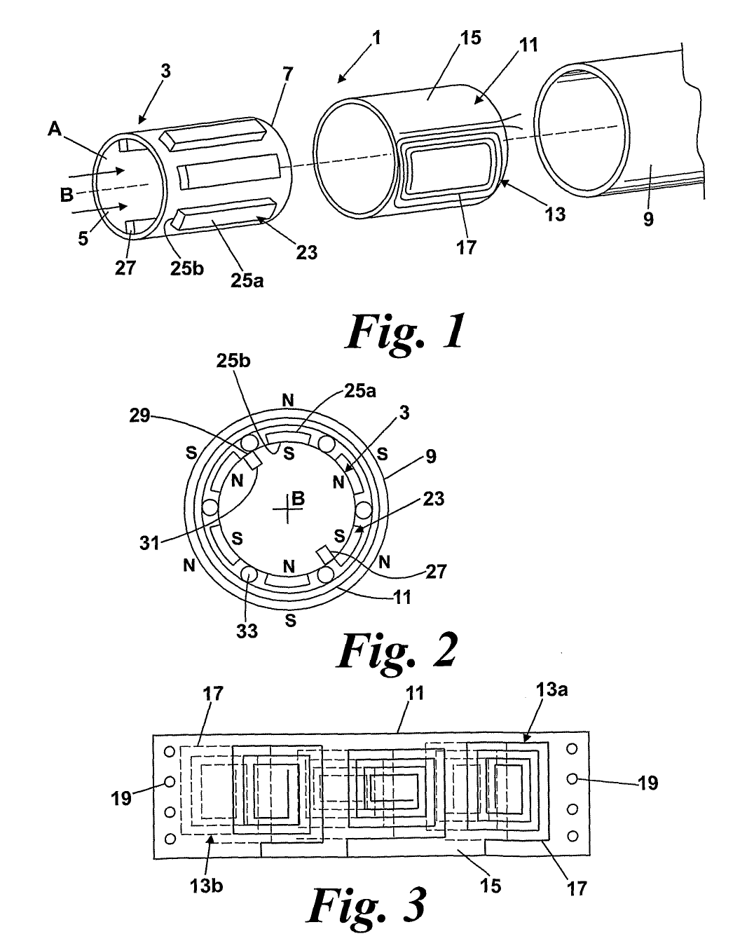

FIG. 1 shows an exploded perspective view of a portion of a first embodiment of an apparatus in accordance with the present invention;

FIG. 2 shows an end view of the embodiment of FIG. 1;

FIG. 3 shows an exploded perspective view of an electrically conductive element showing hidden detail, forming a part of an embodiment of an apparatus in accordance with the present invention;

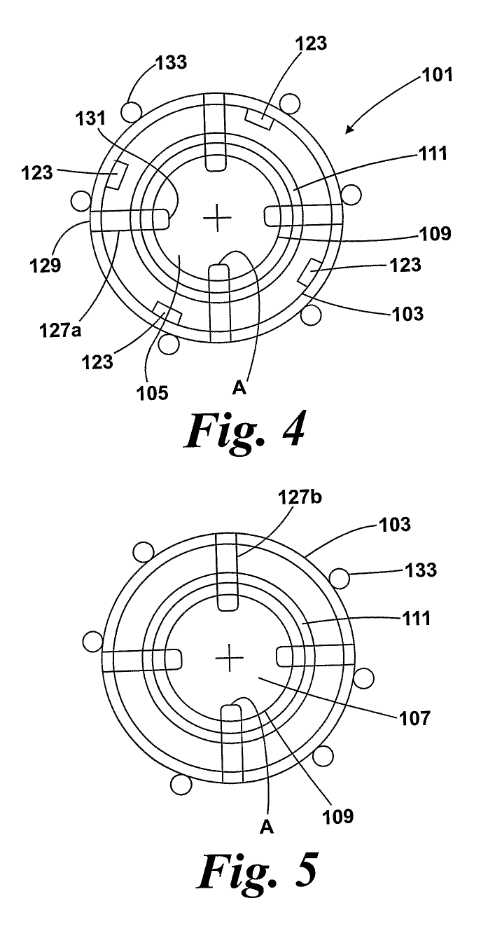

FIG. 4 shows a view from a first end of a second embodiment of an apparatus in accordance with the present invention;

FIG. 5 shows a view from a second end of the embodiment of FIG. 4;

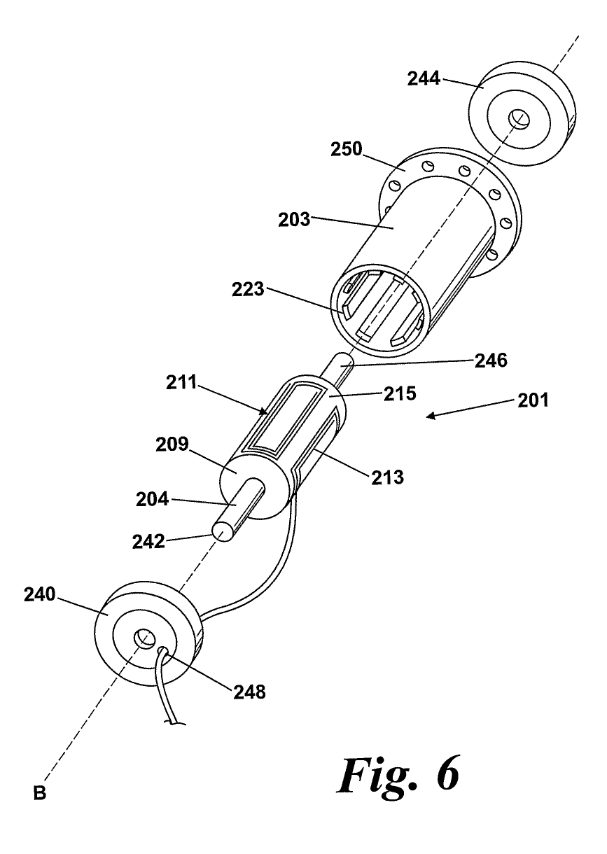

FIG. 6 shows an exploded perspective view of a third embodiment of an apparatus in accordance with the present invention;

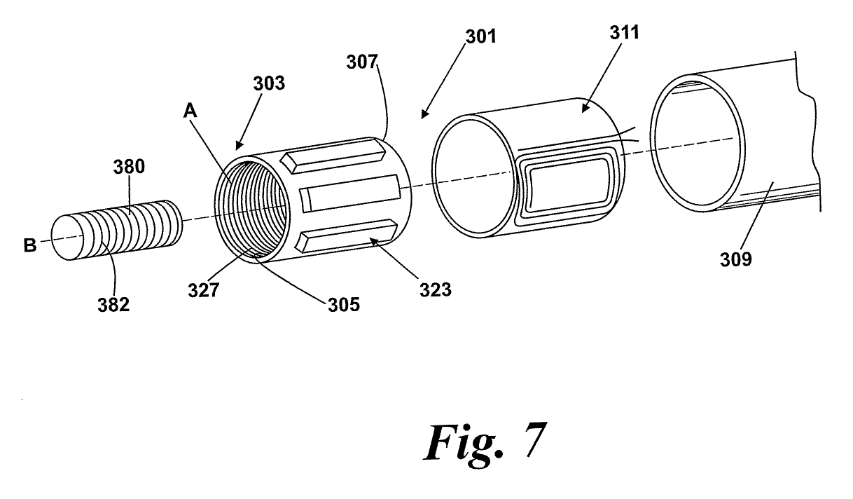

FIG. 7 shows an exploded perspective view of a fourth embodiment of an apparatus in accordance with the present invention;

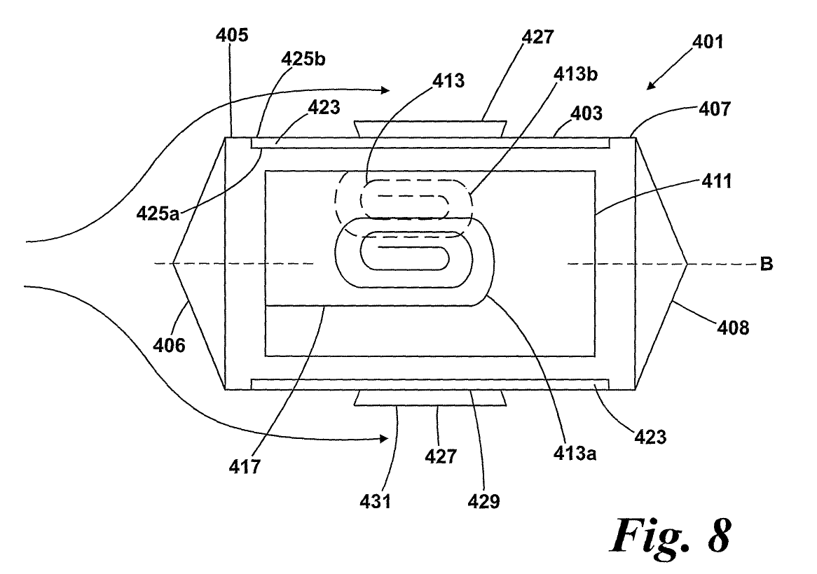

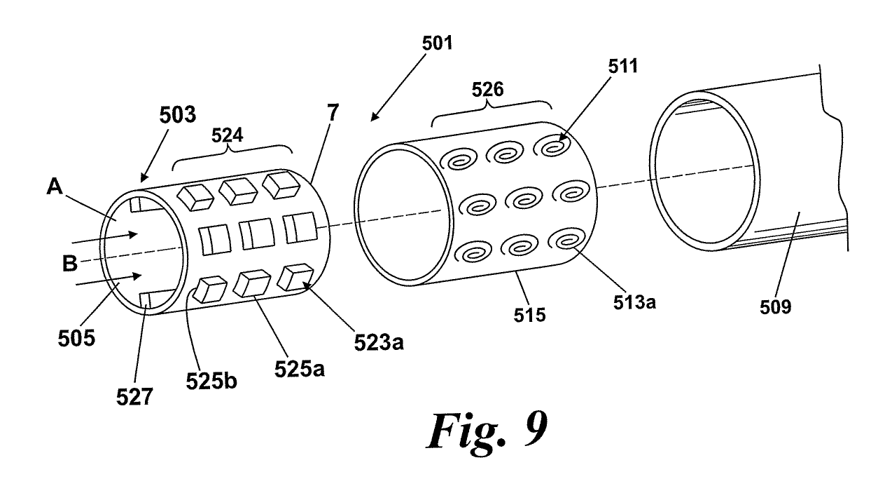

FIG. 8 shows a cross sectional view of a fifth embodiment of an apparatus in accordance with the present invention;

FIG. 9 shows an exploded perspective view of a sixth embodiment of an apparatus in accordance with the present invention; and

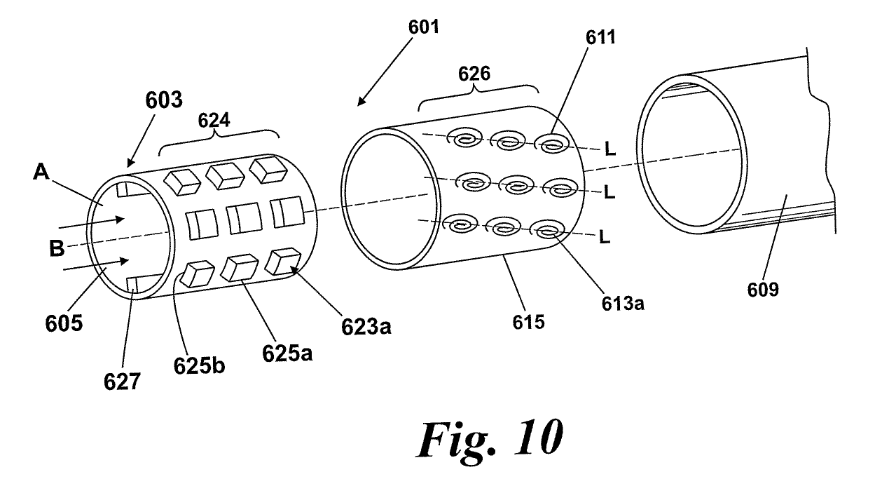

FIG. 10 shows an exploded perspective view of a seventh embodiment of an apparatus in accordance with the present invention.

Referring now to FIGS. 1 to 3 in particular, there is shown an apparatus 1.

It is to be appreciated that although the foregoing describes the operation of the invention as a pump, the invention could be operated in reverse, that is, as an electric generator assembly, and this will be described in more detail later.

The apparatus 1 comprises a rotor in the form of an elongate tubular member 3 enclosing a substantially cylindrical space A. The elongate tubular member 3 has a first open end 5 defining a fluid inlet and a second open end 7 defining a fluid outlet. In the embodiment shown with reference to FIGS. 1 to 3, the apparatus 1 further comprises a tubular stator 9 made from magnetically conductive material, whereby the tubular stator 9 is disposed radially outwardly of the elongate tubular member 3. At least a part of the stator 9 is axially aligned with at least a part of the elongate tubular member 3, and in this way, at least a part of the stator 9 overlaps with at least a part of the elongate tubular member 3.

The apparatus 1 further comprises an electrically conductive element 11 which is disposed radially outwardly of the elongate tubular member 3 but radially inwardly of the stator 9. At least a part of the electrically conductive element 11 is axially aligned with at least a part of the elongate tubular member 3, and in this way, at least a part of the electrically conductive element 11 overlaps with at least a part of the elongate tubular member 3 and at least a part of the stator 9. It is to be appreciated that the apparatus 1 can incorporate any type of electrically conductive element 11 which is able to control rotation of the rotor 3 about the longitudinal axis B. However, in the embodiment of FIGS. 1 to 3, the apparatus 1 comprises an electrically conductive element 11 in the form of a plurality of coils 13 disposed on a tubular flexible substrate 15. It is to be appreciated that the flexible substrate 15 may be made from any suitable material which is flexible and which lends itself to being formed into a tubular shape and allows the coils 13 to be mounted thereon. However, a preferred material for use as the flexible substrate 15 is Kapton®. The electrically conductive element 11, and in particular the flexible substrate 15, is disposed around and against the inner surface of the tubular stator 9, and in this way, the electrically conductive element 11 is supported by the tubular stator 9.

FIG. 3 shows in more detail the configuration of the coils 13 disposed on the flexible substrate 15, and shows the electrically conductive element 11 before it has been formed into a tubular shape and wrapped around the inner surface of the stator 9. The coils 13 may be formed by an electrical wire 17 disposed on the flexible substrate 15 and arranged in a spiral shape, but may alternatively be formed by electrically conductive tracks formed in the flexible substrate 15 and arranged in a spiral shape. As can be clearly seen from FIG. 3, a plurality of first coils 13a are connected in series with each other and are disposed side by side on a first surface of the flexible substrate 15. In addition, a plurality of second coils 13b are connected in series with each other and are disposed side by side on an opposite surface of the flexible substrate 15. As can be clearly seen, each coil 13 lies substantially flat against the flexible substrate 15, and the free ends of the wires 17 forming the coils 13 are connectable to a control apparatus comprising a power source (not shown) to provide a current flow through the coils 13 when required. Further, as can be clearly seen from FIG. 3 in particular, a portion of each of the first coils 13a overlaps with a respective portion of each of the second coils 13b.

The correct configuration of the electrically conductive element 11 may be formed by wrapping the flexible substrate 15 around the inner surface of the tubular stator 9 for support, and then securing it in position. The flexible substrate 15 may be secured in position by any suitable means but it is envisaged that the flexible substrate 15 may be formed with a plurality of holes 19 at each end thereof. The inner surface of the tubular stator 9 is provided with a plurality of co-operating projections (not shown) which register with the holes 19 in order to ensure that the flexible substrate 15 is correctly arranged inside and against the tubular stator 9.

It is however to be appreciated that the flexible substrate may or may not be present. For example, the coil configuration described above may be achieved without the presence of the tubular flexible substrate. In this way, each first coil 13a could lie substantially flat against a respective second coil 13b, and a part of each first coil 13a could overlap with a part of a respective second coil 13b.

Moreover, the coils 13a and 13b can be encased within plastic, for example by means of injection moulding. In this way, the coils 13a and 13b are maintained in the correct configuration, thereby assisting in the assembly and functionality of the apparatus 1.

Alternatively, the coils 13a and 13b may be firstly mounted on a plastic frame (not shown) which may itself then be encased in plastic, for example, by means of injection moulding. The plastic frame may comprise a plurality of hooks which register with the coils 13a and 13b in order to assist in the mounting of the coils 13a and 13b on the plastic frame.

In the embodiment shown with reference to FIGS. 1 to 3, the rotor 3 is provided with a plurality of magnets 23 disposed around its outer surface. Each magnet 23 is elongate in nature and extends substantially parallel to the longitudinal axis B of the rotor 3. Each magnet 23 has a first surface 25a, and a second surface 25b which is attached to the outer surface of the rotor 3. The magnets 23 are polarized such that the first surfaces 25a of adjacent magnets 23 are oppositely polarised.

The rotor 3 further comprises a conveying means in the form of a plurality of radially extending impellers 27 disposed on an inner surface of the rotor 3. In the embodiment shown in FIGS. 1 to 3, the rotor 3 comprises two impellers 27, but it is to be appreciated that the rotor 3 could comprise any number of impellers 27. Each impeller 27 comprises a first end 29 which is secured to the inner surface of the rotor 3, and a free second end 31. The distance between the first 29 and second 31 ends is relatively short and as a result, the impellers 27 do not meet at or near the longitudinal axis B of the rotor 3. In this way, although the impellers 27 provide a useful pumping action to fluid for example when the rotor 3 rotates, the impellers 27 do not unduly restrict fluid flow when the rotor 3 is either rotating or is stationary.

In this embodiment, the impellers 27 extend substantially along the complete length of the elongate tubular member 3 between the first 5 and second 7 ends.

It is to be appreciated that in addition to the radially extending impellers 27, the rotor could additionally include a plurality of propellers (not shown) disposed around the periphery of either end of the rotor 3, and disposed on an outer surface of the rotor 3.

In this way, the rotor 3 would be able to pump fluid around the outside of the apparatus 1 as well as through the hollow portion.

The apparatus 1 further comprises a support assembly in the form of a plurality of ball bearings 33 (in this embodiment, six), arranged between the rotor 3 and the tubular stator 9. The ball bearings 33 ensure that the rotor 3 is maintained in position relative to the longitudinal axis B whilst reducing friction and allowing for rotation of the rotor 3 when required.

In this way, the apparatus 1 of the present invention can function as a pump, and whilst having numerous applications in for example, the power tool industry, is particularly suited to insertion into a patient's bloodstream in order to increase blood pressure in various parts of the patient's body when required. In particular, the rotor 3 and the ball bearings 33 may be inserted into the bloodstream of a patient, with the rotor 3 maintained in position by means of the ball bearings 33. The tubular stator 9 and the electrically conductive element 11 may be mounted externally to the patient's bloodstream, with the wall of the patient's blood vessel disposed between the rotor 3 and the tubular stator 9. In this way, there is minimal resistance to the flow of blood by the various components of the apparatus 1, and furthermore, the apparatus 1 is less invasive to the patient. Whilst the torque provided to the rotor 3 may be reduced using this configuration, because of the presence of the wall of the blood vessel between the rotor 3 and the electrically conductive element 11, a useful pumping action may still be provided.

In the event that the apparatus 1 is to be inserted into the bloodstream of a patient, the components of the apparatus 1 may be made from surgical grade materials such as surgical steel.

The apparatus 1 further comprises a control apparatus (not shown) which comprises a power supply connected to the coils 13. The control apparatus controls operation of the apparatus 1 by supplying electrical current to the coils 13 when it is desired to rotate the rotor 3. The speed of rotation of the rotor 3 may be altered by means of varying the electric current supplied to the coils 13.

On operation of the control apparatus, the rotor 3 rotates, thereby drawing the fluid in a direction from the inlet 5 towards the outlet 7. This flow path is illustrated by arrows in FIG. 1.

By virtue of the provision of a fluid flow path through the substantially cylindrical space A enclosed by the rotor 3, the fluid flow path has an increased cross-sectional area and the fluid flow is therefore less restricted than the fluid flow in prior art apparatuses. In this way, the rotor 3 is substantially hollow, with an open space through its centre, and no central shaft which would otherwise introduce drag.

Referring now to FIGS. 4 and 5, there is shown a second embodiment of an apparatus 101. Again, it is to be appreciated that although the foregoing describes the operation of the invention as a pump, the invention could be operated in reverse, that is, as a generator assembly, and this will be described in more detail later.

The apparatus is similar to the embodiment described with reference to FIGS. 1 to 3, in that it comprises a rotor in the form of an elongate tubular member 103 enclosing a substantially cylindrical space A, a tubular stator 109 made from magnetically conductive material, and an electrically conductive element 111 in the form of a plurality of coils disposed on a tubular flexible substrate. The flexible substrate is disposed around and against the outer surface of the tubular stator 109, and in this way, the electrically conductive element 111 is supported by the tubular stator 109. Moreover, the elongate tubular member 103 is provided with a plurality of magnets 123 disposed around its inner surface. Each magnet 123 is elongate in nature and extends substantially parallel to the longitudinal axis B of the rotor 103.

However, the embodiment of FIGS. 4 and 5 differs from that shown in FIGS. 1 to 3 in that although the elongate tubular member 103 at least partially overlaps with the electrically conductive element 111, the elongate tubular member 103 is disposed radially outwardly of the electrically conductive element 111.

The elongate tubular member 103 comprises a conveying means in the form of a plurality of first discrete impellers 127a disposed around the periphery of the inner surface of the elongate tubular member 103 adjacent inlet 105, and a plurality of second discrete impellers 127b disposed around the periphery of the inner surface of the elongate tubular member 103 adjacent the outlet 107. The first 127a and second 127b impellers are of a similar configuration to the impellers 27 of FIGS. 1 to 3, but do not extend along the complete length of the elongate tubular member 103 between the inlet 105 and the outlet 107 and are instead discrete and are disposed adjacent either end. Moreover, the distance between the first 129 and second 131 ends is slightly greater in this embodiment to account for the presence of the electrically conductive element 111 and stator 109 radially inwardly of the elongate tubular member 103. Nevertheless, the impellers 127a and 127b still do not meet at or near the longitudinal axis B of the elongate tubular member 103.

The apparatus 101 further comprises a support assembly in the form of a plurality of ball bearings 133 disposed outwardly of the rotor 103. The support assembly further comprises an arm (not shown) having a first end attached to an end of the stator 109 and a second end to be fixed to a suitable anchoring means.

It is to be appreciated that the apparatuses 1, 101, of FIGS. 1 to 5 can be operated in reverse as an electric generator assembly. That is, the rotor 3, 103, could be free running; that is, rotated as a result of fluid flow therethrough, and in either direction. In this way, in the event that the electric generator assembly is disposed in a fluid flowpath, the flow of fluid through the substantially cylindrical space through the centre of the elongate tubular member and along the longitudinal axis B results in the rotation of the rotor 3, 103 about the longitudinal axis B as a result of the interaction of the fluid with the impellers 27, 127. This in turn results in the coils 13, 113 experiencing an alternating magnetic field, which results in the generation of an electro motive force in the coils 13, 113. When the coils 13, 113 are connected to a load, an electric current and power is generated.

It is to be appreciated that when the apparatus is being operated as a means for conveying a body from one place to another, the conveying means in the form of impellers for example, causes the body to move in a direction from the inlet towards the outlet as the rotor rotates. However, when the apparatus is being operated in reverse as an electric generator assembly, as the fluid for example moves between the inlet and the outlet, it interacts with the impellers which are arranged so that as the fluid flows through the rotor, the impellers cause the rotor to rotate to thereby generate the electro-motive force.

The applications of the invention when being operated as an electric generator assembly are numerous. For example, the electric generator assembly is particularly suited to insertion into a patient's bloodstream in order to utilise the flow of blood therethrough to provide power to an implanted electrical device in another part of the patient's body. In particular, the rotor 3 and the ball bearings 33 may be inserted into the bloodstream of a patient, with the rotor 3 maintained in position by means of the ball bearings 33. The tubular stator 9 and the electrically conductive element 11 may be mounted externally to the patient's bloodstream, with the wall of the patient's blood vessel disposed between the rotor 3 and the tubular stator 9. In this way, there is minimal resistance to the flow of blood by the various components of the electric generator assembly and furthermore, the electric generator assembly is less invasive to the patient.

The applications of the invention when being operated as a pump are also numerous. For example, as well as the medical applications described in detail above, the apparatus 1, 101 could be utilised in a vacuum cleaner assembly on account of the suction generated on rotation of the rotor 3, 103.

Referring now to FIG. 6, there is shown a third embodiment of an electric motor assembly 201. Again, it is to be appreciated that although the foregoing describes the operation of the invention as a motor assembly, the invention could be operated in reverse, that is, as a generator assembly, and this will be described in more detail later.

The electric motor assembly 201 comprises a rotor in the form of an elongate tubular member 203, and a generally cylindrical stator 209 which is mounted on a shaft 204. The motor assembly 201 further comprises an electrically conductive element 211, which is identical to the electrically conductive element included in the embodiments of the motor assemblies shown in FIGS. 1 to 5 and which includes a plurality of coils 213 disposed on a tubular flexible substrate 215.

The electrically conductive element 211 is disposed around and against the exterior surface of the tubular stator 209, and in this way, the electrically conductive element 211 is supported by the tubular stator 209. Moreover, the elongate tubular member 203 is provided with a plurality of magnets 223 disposed around its inner surface. Each magnet 223 is elongate in nature and extends substantially parallel to the longitudinal axis B of the rotor 203.

When assembled, the electric motor assembly is arranged so that the rotor 203 is disposed outwardly of both the stator 209 and the electrically conductive element 211, so that the rotor 203 overlaps with the stator 209 and the electrically conductive element 211.

The motor assembly 201 further comprises a support assembly in the form of a first bearing 240 disposed on a first end 242 of the shaft 204, and a second bearing 244 disposed on a second end 246 of the shaft 204. The first bearing 240 comprises a through hole 248 through which the free end of the coils 213 can pass in order to connect the electrically conductive element 211 to a source of power (not shown).

The motor assembly 201 further comprises a drive flange 250 which is connected to a drive element (not shown). In this way, when current flows through the coils 213, the rotor 203 is caused to rotate, which results in the rotation of the drive flange 250 and hence the drive element connected thereto.

It is to be appreciated that the drive flange 250 may be connected to for example a propeller shaft of a car, so that when electric current flows through the coils 213, the propeller shaft rotates.

It is to be appreciated that the motor assembly 201 of FIG. 6 can be operated in reverse. That is, the rotor 203 could be free running; that is, rotated as a result of rotation of the drive flange 250, and in either direction. In this way, in the event that the rotor 203 rotates about the longitudinal axis B, the coils 213 experience an alternating magnetic field, which results in the generation of an electro motive force in the coils 213. When the coils 213 are connected to a load, an electric current and power is generated.

Referring now to FIG. 7, there is shown a fourth embodiment of an apparatus 301 which may be operated as a motor assembly. Again, it is to be appreciated that although the foregoing describes the operation of the invention as a motor assembly, the invention could be operated in reverse, that is, as an electric generator assembly.

The electric motor assembly 301 is similar to the embodiment described with reference to FIGS. 1 to 3, in that it comprises a rotor in the form of an elongate tubular member 303 enclosing a substantially cylindrical space A, a tubular stator 309 made from magnetically conductive material, and an electrically conductive element 311 in the form of a plurality of coils disposed on a tubular flexible substrate. The flexible substrate is disposed around and against the inner surface of the tubular stator 309, and in this way, the electrically conductive element 311 is supported by the tubular stator 309. Moreover, the elongate tubular member 303 is disposed inside the tubular stator 309 and is provided with a plurality of magnets 323 disposed around its outer surface. Each magnet 323 is elongate in nature and extends substantially parallel to the longitudinal axis B of the rotor 303.

As can be seen from the Figure, when assembled, at least a part of the elongate tubular member 303 overlaps with the electrically conductive element 311, and the elongate tubular member 303 is disposed radially inwardly of the electrically conductive element 311.

The elongate tubular member 303 comprises a conveying means in the form of screw threads 327 disposed around the periphery of the inner surface of the elongate tubular member 303.

The assembly 301 further comprises an actuator 380 which is shaped and sized so as to fit inside the substantially cylindrical hollow space A within the elongate tubular member 303. The outer surface of the actuator 380 comprises screw threads 382 which correspond to the screw threads 327 on the periphery of the inner surface of the elongate tubular member 303.

The motor assembly 301 further comprises a support assembly in the form of a plurality of ball bearings (not shown) disposed outwardly of the rotor 303.

In the event that current flows through the electrically conductive element, the rotor and in particular the elongate tubular member rotates. The rotor is prevented from moving along the longitudinal axis B and as a result, as the rotor rotates, the actuator 380 moves in a direction from the inlet 305 towards the outlet 307.

Referring now to FIG. 8, there is shown a fifth embodiment of an apparatus 401 which may be operated as a motor assembly.

The apparatus 401 comprises a rotor in the form of an elongate tubular member 403 having a first end 405 and a second end 407. The first end 405 comprises a first chamfered end piece 406, and the second end 407 comprises a second chamfered end piece 408. The apparatus 401 further comprises an electrically conductive element 411 which is disposed radially inwardly of and inside the elongate tubular member 403. The electrically conductive element 411 is axially aligned with the elongate tubular member 403, and in this way, the electrically conductive element 411 overlaps with the elongate tubular member 403.

It is to be appreciated that the apparatus 401 can incorporate any type of electrically conductive element 411 which is able to control rotation of the rotor 403 about the longitudinal axis B. However, in the embodiment of FIG. 8, the apparatus 401 comprises an electrically conductive element 411 in the form of a plurality of coils 413 arranged in a tubular configuration. To elaborate, the coils 413 are arranged in a similar formation to those described with reference to FIG. 3 but without the presence of a tubular flexible substrate between the first and second coils. The electrically conductive element 411 is disposed around and against the outer surface of a tubular stator (not shown), and in this way, the electrically conductive element 411 is supported by the tubular stator.

The coils 413 may be formed by an electrical wire 417 arranged in a spiral shape. It is to be appreciated that as shown in FIG. 3, the electrically conductive element 411 is disposed such that a plurality of first coils 413a are connected in series with each other and are disposed side by side, and a plurality of second coils 413b are connected in series with each other and are disposed side by side. As can be clearly seen, the first coils 413a lie substantially flat against the second coils 413b, and the free ends of the wires 417 forming the coils 413 are connectable to a control apparatus comprising a power source (not shown) to provide a current flow through the coils 413 when required. Further, as can be clearly seen, a portion of each of the first coils 413a overlaps with a portion of each of the second coils 413b.

In this embodiment, the rotor 403 is provided with a plurality of magnets 423 disposed around its inner surface. Each magnet 423 is elongate in nature and extends substantially parallel to the longitudinal axis B of the rotor 403. Each magnet 423 has a first surface 425a, and a second surface 425b which is attached to the inner surface of the rotor 403. The magnets 423 are polarized such that the first surfaces 425a of adjacent magnets 423 are oppositely polarised.

The rotor 403 further comprises a conveying means in the form of a plurality of radially extending propellers 427 disposed on an outer surface of the rotor 403. In the embodiment shown in FIG. 8, the rotor 403 comprises two impellers 427, but it is to be appreciated that the rotor 403 could comprise any number of impellers 427. Each impeller 427 comprises a first end 429 which is secured to the outer surface of the rotor 403, and a free second end 431. The distance between the first 429 and second 431 ends is relatively short. In this way, although the impellers 427 provide a useful fluid pumping action, for example when the rotor 403 rotates, as will be described below, the impellers 427 do not unduly restrict fluid flow when the rotor 403 is either rotating or is stationary.

In this embodiment, the impellers 427 extend substantially along the complete length of the rotor 403 between the first 405 and second 407 ends.

The apparatus 401 further comprises a control apparatus (not shown) which comprises a power supply connected to the coils 413. The control apparatus controls operation of the apparatus 401 by supplying electrical current to the coils 413 when it is desired to rotate the rotor 403. The speed of rotation of the rotor 403 may be altered by means of varying the electric current supplied to the coils 413.

On operation of the control apparatus, the rotor 403 rotates, thereby drawing the fluid in a direction from the first end 405 towards the second end 407. This flow path is illustrated by arrows in FIG. 8.

The apparatus 401 operates as follows.

In the event that electrical current flows through the coils 413, the rotor 403 rotates and the movement of the propellers urges fluid present to flow in a direction represented by the arrows in FIG. 8, such that the fluid flows around the rotor. The first 406 and second 408 chamfered ends prevent fluid from flowing through the centre of the rotor and their aerodynamic configuration ensures that the fluid is pumped smoothly around the outer surface of the rotor 403.

Referring now to FIG. 9, there is shown a sixth embodiment of an apparatus 501 which may be operated as a motor assembly. It is to be appreciated that those features of the apparatus 501 which are in common with the embodiment of FIG. 1 are provided with like numerals but increased by 500.

The apparatus 501 is identical to the embodiment shown in FIG. 1 apart from the configuration of the electrically conductive element 511 and the magnets 523. In particular, the apparatus 501 comprises a plurality of magnets 523a disposed end to end longitudinally of the exterior surface of the elongate tubular member 503, such that a magnet set 524 is formed along the length of the elongate tubular member 503. In this way, instead of having a single magnet extending along the length of the elongate tubular member 503, as is the case in the embodiment of FIG. 1, the apparatus 501 comprises a plurality of discrete magnets 523a. Further, a plurality of magnet sets 524 are disposed around the periphery of the exterior surface of the elongate tubular members 503.

Moreover, the apparatus 501 comprises a plurality of electrically conductive coils 513a disposed end to end longitudinally of the exterior surface of a tubular support 515 which could be either flexible or rigid. In particular, the apparatus 501 comprises a plurality of electrically conductive coils 513a disposed end to end such that a coil set 526 is formed along the length of the tubular support 515. Further, a plurality of coil sets 526 are disposed around the periphery of the tubular support.

It is to be appreciated that alternatively, the coil 526 could be disposed on the interior surface of the tubular stator 509. It is also to be appreciated that in this embodiment, there is no overlapping of electrically conductive coils 513a as is the case with the embodiment of FIG. 1.

As can be clearly seen from FIG. 9, when the apparatus 501 is assembled, an electrically conductive coil 513a overlaps with a respective magnet 523a.

Referring now to FIG. 10, there is shown a seventh embodiment of an apparatus 601 which may be operated as a motor assembly. It is to be appreciated that those features of the apparatus 601 which are in common with the embodiment of FIG. 9 are provided with like numerals but increased by 100.

The apparatus 601 is identical to the embodiment shown in FIG. 9 apart from the configuration of the electrically conductive element 611. In particular, the apparatus 601 comprises a plurality of electrically conductive coils 613a disposed end to end on the exterior surface of a tubular support 615 which could be either flexible or rigid. In particular, the apparatus 601 comprises a plurality of electrically conductive coils 613a disposed end to end such that a coil set 626 is formed along the length of the tubular support 615. Further, a plurality of coil sets 626 are disposed around the periphery of the tubular support 615. However, this embodiment differs from that of FIG. 9 in that the lines L running along and defining each coil set 626 are disposed at a small angle to the longitudinal axis B of the rotor 603, and not substantially parallel to the longitudinal axis of the rotor 603 as is the case with the embodiment of FIG. 9.

In this way, as the rotor 603 rotates, successive magnets 623a and electrically conductive coils 613a overlap with each other. So a coil 613a and a magnet 623a nearest one end of the rotor 603 would overlap first and that would cause the rotor 603 to rotate, which in turn would cause the next coil 613a and magnet 623a in the set to overlap, which would cause further rotation of the rotor 603, which in turn would cause the next coil 613a and magnet 623a to overlap, and so on.

It is to be appreciated that this coil and magnet configuration could be used on any of the embodiments described herein.

It will be appreciated by persons skilled in the art that the above embodiments have been described by way of example only, and not in any limitative sense, and that various alterations and modifications are possible without departing from the scope of the invention as defined by the appended claims.

It will be also be understood that those embodiments described as electric motors may be used in reverse as electric generators and those described as electric generators may be used in reverse as electric motors.

1. An apparatus comprising:—
(i) a rotor supported for rotation about a longitudinal axis, said rotor comprising an elongate tubular member enclosing a substantially cylindrical space, said elongate tubular member having a first open end defining an inlet, and a second open end defining an outlet; and
(ii) at least one electrically conductive element for generating a magnetic field when electric current flows therethrough and for controlling rotation of the rotor, wherein at least a part of at least one said electrically conductive element is aligned axially with at least a part of said elongate tubular member,
wherein said elongate tubular member comprises conveying means adapted so that upon rotation of said rotor, at least one body is caused to move in a direction from said inlet toward said outlet, through the substantially cylindrical space.

2. (canceled)

3. (canceled)

4. An apparatus as claimed in claim 1, wherein the conveying means is adapted so that upon rotation of said rotor, fluid is conveyed in a direction from said inlet towards said outlet through the substantially cylindrical space.

5. An apparatus as claimed in claim 1, wherein the conveying means is adapted so that upon rotation of said rotor, a solid body is caused to move in a direction from said inlet towards said outlet through the substantially cylindrical space.

6. An apparatus as claimed in claim 1, wherein at least one said electrically conductive element is disposed radially outwardly of said elongate tubular member.

7. An apparatus as claimed in claim 1, wherein said elongate tubular member is disposed radially outwardly of at least one said electrically conductive element.

8. An apparatus as claimed in claim 1, wherein the rotor comprises a plurality of magnets disposed around the periphery of said elongate member.

9. An apparatus as claimed in claim 1, wherein the rotor comprises a plurality of magnets disposed around the periphery of an outer surface of said elongate tubular member, and at least a part of at least one said electrically conducting element is disposed such that when electric current flows therethrough, said magnets are disposed in the magnetic field generated as a result of said electric current.

10. An apparatus as claimed in claim 1, wherein the rotor comprises a plurality of magnets disposed around the periphery of an inner surface of said elongate tubular member, and at least a part of at least one said electrically conducting element is disposed such that when electric current flows therethrough, said magnets are disposed in the magnetic field generated as a result of said electric current.

11. (canceled)

12. An apparatus as claimed in claim 8, wherein at least one said magnet is elongate, with said magnets being arranged around the periphery of said elongate tubular member so that each said elongate magnet extends substantially parallel to said longitudinal axis of said rotor.

13. (canceled)

14. An apparatus as claimed in claim 1, wherein the apparatus further comprises a tubular stator, wherein at least a part of said stator is axially aligned with at least a part of said elongate tubular member.

15-25. (canceled)

26. An apparatus as claimed in claim 1, wherein said conveying means comprises at least one radially extending impeller disposed on an inner surface of the elongate tubular member, each said impeller having a first end attached to the inner surface of said elongate tubular member, and a free second end.

27-29. (canceled)

30. An apparatus as claimed in claim 1, wherein at least one said electrically conductive element comprises at least one electrical conductor disposed on a tubular flexible substrate.

31-33. (canceled)

34. An apparatus as claimed in claim 30, wherein said electrically conductive element comprises:—at least one first electrically conductive coil disposed on an inner surface of said tubular flexible substrate such that each said first electrically conductive coil lies substantially flat against the inner surface of said tubular flexible substrate; and at least one second electrically conductive coil disposed on an outer surface of said tubular flexible substrate such that each said second electrically conductive coil lies substantially flat against the outer surface of said tubular flexible substrate, wherein the longitudinal axes extending through the centre of said first and second coils are each substantially perpendicular to said longitudinal axis of said rotor.

35. An apparatus as claimed in claim 1, wherein said electrically conductive element comprises:—
(i) at least one first electrically conductive coil wherein the longitudinal axis extending through the centre of at least one said first coil is substantially perpendicular to said longitudinal axis of said rotor; and
(ii) at least one second electrically conductive coil wherein the longitudinal axis extending through the centre of at least one said second coil is substantially perpendicular to said longitudinal axis of said rotor;
wherein at least one said first electrically conductive coil lies in substantially the same plane as at least one said second electrically conductive coil, and wherein at least a part of at least one said first electrically conductive coil overlaps with at least a part of at least one said second electrically conductive coil.

36. An apparatus as claimed in claim 1, wherein said electrically conductive element comprises a plurality of first electrically conductive coils connected in series with each other and a plurality of second electrically conductive coils connected in series with each other.

37. An apparatus as claimed in claim 36, wherein said electrically conductive coils are arranged such that at least a part of each said first electrically conductive coil overlaps with at least a part of a respective said second electrically conductive coil.

38-56. (canceled)

57. An electric motor assembly comprising:—
(i) a rotor supported for rotation about a longitudinal axis;
(ii) at least one electrically conductive element for generating a magnetic field when electric current flows therethrough and for controlling rotation of the rotor; and
(iii) a stator disposed radially inwardly of said rotor,
wherein at least one said electrically conductive element is disposed radially outwardly of said stator.

58. An electric motor assembly as claimed in claim 57, wherein said electrically conductive element is disposed between said stator and said rotor.

59. An electric motor assembly as claimed in claim 57, wherein said rotor comprises an elongate tubular member enclosing a substantially cylindrical space, said elongate tubular member having a first open end defining an inlet, and a second open end defining an outlet.

60. An electric motor assembly as claimed in claim 59, wherein said elongate tubular member comprises conveying means adapted so that upon rotation of said rotor, fluid is caused to move in a direction from said inlet toward said outlet through the substantially cylindrical space.

61-67. (canceled)

68. An electric motor assembly comprising:—
(i) a rotor supported for rotation about a longitudinal axis; and
(ii) at least one electrically conductive element for generating a magnetic field when electric current flows therethrough and for controlling rotation of the rotor,
wherein said rotor comprises a plurality of magnets disposed end to end and substantially parallel to said longitudinal axis.

69. An electric motor assembly as claimed in claim 68, wherein said electrically conductive element comprises a plurality of electrically conductive coils disposed end to end and substantially parallel to said longitudinal axis such that each magnet overlaps with a respective electrically conductive coil.

70-82. (canceled)
